(19) United States
(12) Patent Application Publication
(10) Pub. No.: US 2005/0224188 A1
(43) Pub. Date: Oct. 13, 2005

(54) Operation mechanism for Romanian blind

(76) Inventor: Leslie Nien, Changhua Hsien (TW)

Correspondence Address: TROXELL LAW OFFICE PLLC;SUITE 1404, 5205 LEESBURG PIKE, FALLS CHURCH, VA, 22041, US

(21) Appl. No.: 10/890,095

(22) Filed: Jul. 14, 2004

(30) Foreign Application Priority Data
Apr. 9, 2004 (TW) 093205435

(51) Int. Cl. E06B 3/48

(52) U.S. Cl. 160/84.01

(57) ABSTRACT

An operation mechanism for Romanian blind includes a Roman blind made up of a blind body of a proper length and width securely attached to the underside of a telescopic upper beam wherein the blind body is equidistantly doubled up for a certain length from top to bottom and sewed up at one side thereof to form a plurality of elongated through holes for horizontal rods to be led and retained therein respectively. At both lateral sides of each elongated through hole are respectively disposed a retaining piece having a C-shaped clamping part detachably mounted at a preset position of the elongated through hole thereon, and a cord-passage hole protruding in vertical position relative to that of the C-shaped clamping part thereof for a pull cord suspending downwards from the upper beam to be led there-through and fixedly tied up to the bottommost cord-passage hole for location thereby. Thus, separately set from the elongated through holes of the blind body thereof, the retaining pieces can be precisely located onto the elongated through holes to clamp tight the horizontal rods retained therein after the blind body along with the horizontal rods thereof are properly trimmed in width according the telescopic upper beam adjusted to fit to the size of a window frame so that the pull cord can be properly held in place according to the adjustment of the retaining pieces to maintain the overall beauty of the blind body in display, increasing the variable changes in decoration and assembly of the present invention to achieve widespread use and boost the competitive power thereof.

### BACKGROUND OF THE INVENTION

The present invention is related to an operation mechanism for Romanian blind, including a blind body of a proper length and width securely attached to the underside of a telescopic upper beam wherein the blind body is equidistantly doubled backwards for a certain length and sewed up at one side thereof to form a plurality of elongated through holes for horizontal rods to be led and retained therein respectively, and retaining pieces each having a C-shaped clamping parts and a cord-passage hole are detachably mounted to both lateral sides of the elongated through holes thereof; whereby, via the separate design thereof, the retaining pieces can be precisely located onto the elongated through holes to clamp tight the horizontal rods retained therein after the blind body along with the horizontal rods thereof are properly trimmed in width relative to the telescopic upper beam adjusted to fit to the size of a window frame so that a pull cord can be properly held in place accordingly to maintain the overall beauty of the blind body in display, increasing the variable changes in decoration and assembly of the present invention to achieve widespread use and boost the competitive power thereof.

Please refer to FIG. 1. A conventional Romanian blind is made up of a Roman blind 10 having a blind body 12 of a proper length and width fixedly attached to the underside of an upper beam 11 wherein the blind body 12 is equidistantly doubled backwards for a certain length from top to bottom and sewed up in equal space to provide a plurality of elongated through holes 14 for horizontal rods 13 to be led and retained therein respectively. A plurality of retaining pieces 16 each having a positioning hoop 15 are symmetrically sewed at both lateral sides of the elongated through holes 14 thereon for a pull cord 17 suspending downwards from the inner side of the upper beam 11 to be led sequentially through the positioning hoops 15 till fixedly tied up to the bottommost positioning hoops 15 thereof. In practical use, the pull cord 17 is drawn to raise upwards the bottommost positioning hoops 15 and sequentially gather upwards the other positioning hoops 15 from bottom to top. Meanwhile, the elongated through holes 14 with the horizontal rods 13 retained therein are raised upwards therewith to fold up the blind body 12 suspending downwards in multi-layers.

There are some drawbacks to such conventional Romanian blind. First, the retaining pieces 16 are fixedly and equidistantly sewed up to both lateral sides of the elongated through holes 14 according to the size of the blind body 12, which are unable to be adjusted relative to the size of a window frame A. When the blind body 12 along with the horizontal rods 13 is trimmed from a cutting line B as shown in FIG. 2 to fit to the size of the window frame A, the pull cord 17 tends to be asymmetrically held in place by the retaining pieces 16 fixedly attached to altered blind body 12, which can mar the overall beauty of the Roman blind 10 in display. Thus, the conventional Romanian blind, disadvantaged in decoration as well as assembly, is quite limited in practical use and reduced in the competitive power thereof.

### SUMMARY OF THE PRESENT INVENTION

It is, therefore, the primary purpose of the present invention to provide an operation mechanism for Romanian blind, including a blind body of a proper length and width securely attached to the underside of a telescopic upper beam wherein retaining pieces each having a C-shaped clamping part and a cord-passage hole are detachably clamped tight to horizontal rods retained at elongated through holes of the blind body therein; whereby, via the separate design thereof, the retaining pieces can be precisely and symmetrically located onto the elongated through holes thereof after the blind body along with the horizontal rods thereof are properly trimmed in width relative to an telescopic upper beam adjusted to fit to the size of a window frame so that a pull cord can be properly held in place accordingly to maintain the overall beauty of the blind body in display, increasing the variable changes in decoration and assembly of the present invention to achieve widespread use and boost the competitive power thereof.

It is, therefore, the second purpose of the present invention to provide an operation mechanism for Romanian blind wherein, via the C-shaped clamping parts thereof, the retaining pieces are precisely located onto the elongated through holes to clamp tight the horizontal rods retained therein or detached there-from for adjusting position thereof in an easy and fast manner.

It is, therefore, the third purpose of the present invention to provide an operation mechanism for Roman blind wherein the retaining pieces are provided with cord-passage holes for the pull cord to be led there-through without being fixedly sewed up to the elongated through holes, facilitating an easy production so as to cut down the cost of processing thereof.

### BRIEF DESCRIPTION OF THE DRAWINGS

FIG. 1 is a perspective view of a conventional Romanian blind.

FIG. 2 is a diagram showing the conventional Romanian blind mounted to a window frame in practical use thereof

FIG. 3 is a perspective exploded view of the present invention.

FIG. 4 is a diagram showing the present invention mounted to a window frame in practical use thereof.

FIG. 5 is a partial and sectional view of another embodiment of the present invention in assembly.

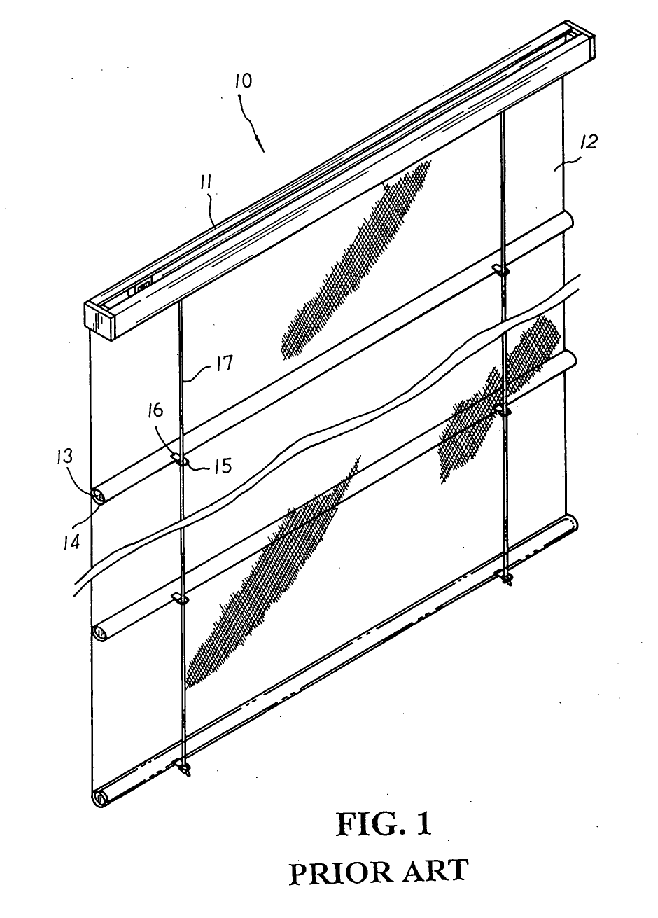

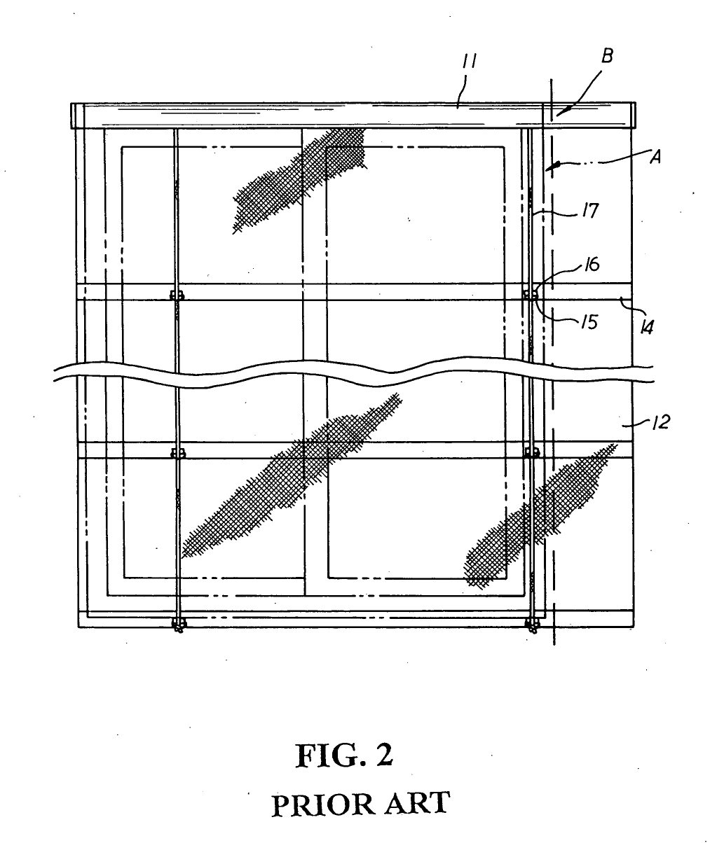

### DETAILED DESCRIPTION OF THE PREFERRED EMBODIMENTS

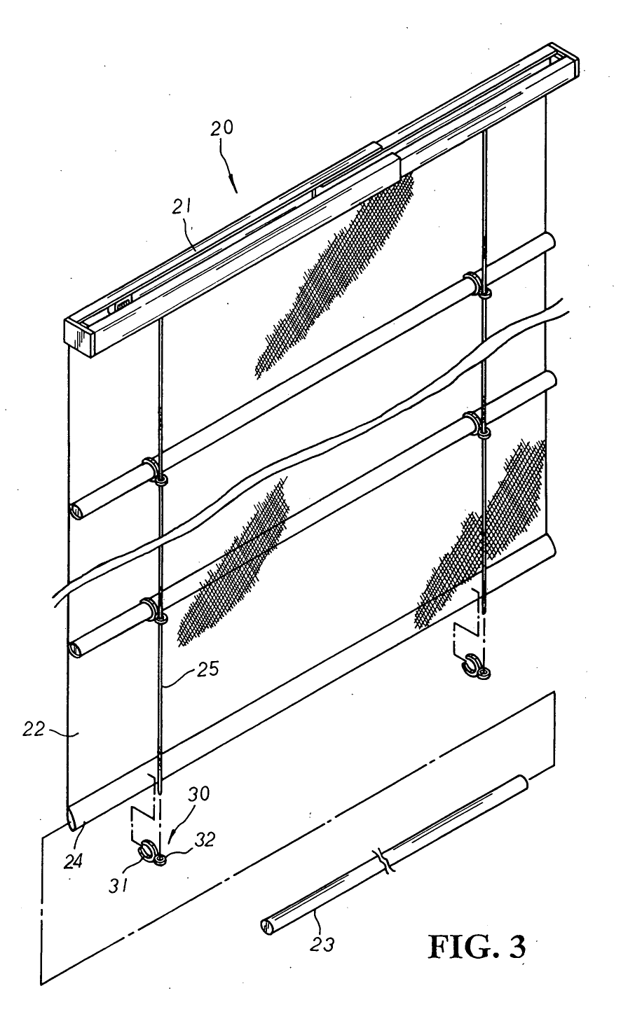

Please refer to FIG. 3. The present invention is related to an operation mechanism for Romanian blind, including a Roman blind 20 made up of a telescopic upper beam 21, and a blind body 22 of a proper length and width securely attached to the underside of the upper beam 21 thereof. The blind body 22 is equidistantly doubled backwards for a certain length from top to bottom and sewed up in equal space at one side thereof to form a plurality of elongated through holes 24 for horizontal rods 23 to be led and retained therein respectively. At both lateral sides of each elongated through hole 24 thereof are respectively disposed a retaining piece 30 having a C-shaped clamping part 31 to be detachably mounted at a preset position of the elongated through hole 24 thereby. The C-shaped clamping part 31 of the retaining piece 30 is conformed to the outer diameter of the horizontal rod 23 thereof so as to clamp tight the horizontal rod 23 retained inside the elongated through hole 24 thereof. The retaining piece 30 also has a cord-passage hole 32 protruding at one side in vertical angle relative to that of the C-shaped clamping part 23 thereof for a pull cord 25 suspending downwards from the interior of the upper beam 21 to be led there-through. The pull cord 25, sequentially led through the cord-passage holes 32 from top to bottom of the blind body 22 thereof, is fixedly tied up to the bottommost cord-passage holes 32 for location thereby. Thus, the pull cord 25 is drawn to lift upwards the bottommost cord-passage holes 32 and bring up the other cord-passage holes 32 from bottom to top in a sequence. Meanwhile, the elongated through holes 24 with the horizontal rods 23 retained therein are raised upwards therewith to fold up the blind body 22 suspending downwards in multi-layers.

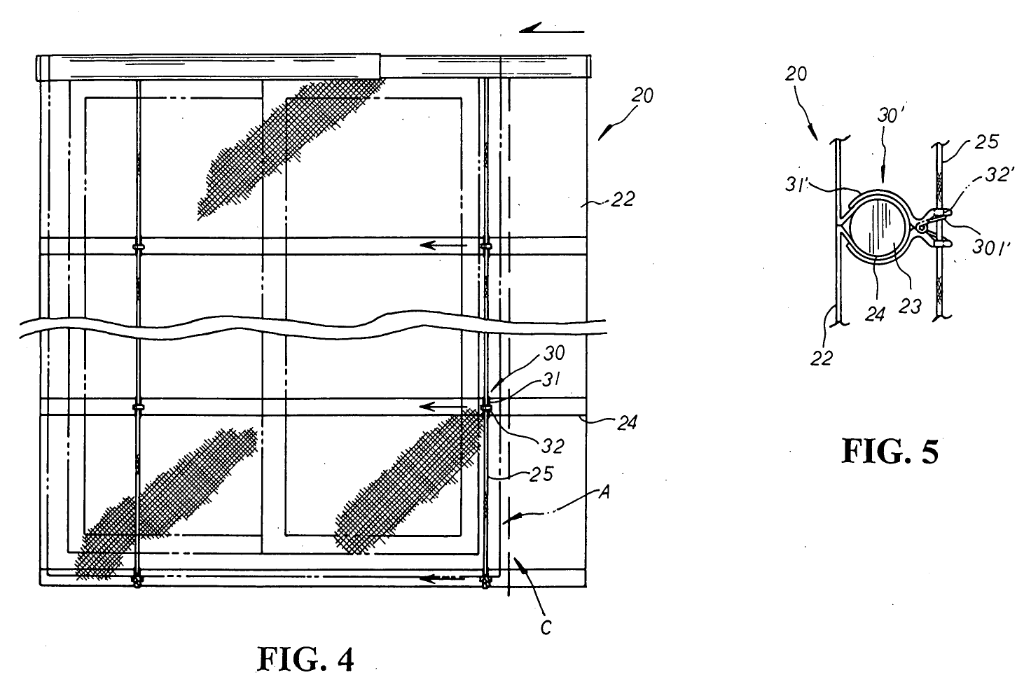

Please refer to FIG. 4. In practical use, the Venetian blind 20 thereof is easily mounted onto a window frame A via the retaining pieces 30 separately set from the elongated through holes 24 of the blind body 22 thereof. The retaining pieces 30 clamped inwards from one side of the elongated through holes 24 are respectively pulled outwards, detaching the C-shaped clamping parts 31 off from the elongated through holes 24 and the horizontal rods 23 as well. The telescopic upper beam 21 is then adjusted in length to suit the size of the window frame A before both the blind body 22 and the horizontal rods 23 are properly trimmed according to the adjusted upper beam 21 from a cutting line C as shown in FIG. 4. The withdrawn retaining pieces 30 are respectively relocated relative to the width of the altered blind body 22 thereof and symmetrically clamped tight at proper positions of the elongated through holes 24 thereon. Thus, the pull cord 25 can be properly held in place according to the adjustment of the retaining pieces 30 to maintain the overall beauty of the blind body 22 in display, increasing the variable changes in decoration and assembly of the present invention to achieve widespread use and boost the competitive power thereof.

Please refer to FIG. 5. The present invention can also be equipped with a plurality of retaining pieces 30′ each made up of a pair of symmetric retaining plates mutually bound together via a torsional spring 301′ wherein an upper and a lower clamping parts 31′ are symmetrically extending at one side of each retaining piece 30′ to precisely clamp tight the elongated through holes 24 and the horizontal rods 23 of the blind body 22 for location thereby, and a pair of upper/lower cord-passage holes are correspondingly protruding at the other side of the retaining piece 30′ thereof for the pull cord 25 to be led downwards there-through respectively.

1. An operation mechanism for Romanian blind, including a Roman blind having a blind body of a proper length and width securely attached to the underside of a telescopic upper beam wherein the blind body is equidistantly doubled backwards for a certain length from top to bottom and sewed up in equal distance at one side thereof to form a plurality of elongated through holes for horizontal rods to be led and retained therein respectively; the present invention being characterized by that,
at both lateral sides of each elongated through hole thereof being respectively disposed a retaining piece having a C-shaped clamping part attached at one side to be detachably mounted to a preset position of the elongated through hole thereby wherein the clamping part of the retaining piece is conformed to the outer diameter of the horizontal rod thereof so as to clamp tight the horizontal rod retained inside the elongated through hole thereof, and a cord-passage hole is protruding at one side of the C-shaped clamping part thereof for a pull cord suspending downwards from the interior of the upper beam to be led there-through; the pull cord, sequentially led through the cord-passage holes from top to bottom of the blind body thereof, is fixedly tied up to the bottommost cord-passage holes for location thereby; thus, separately set from the elongated through holes of the blind body thereof, the retaining pieces can be precisely located onto the elongated through holes to clamp tight the horizontal rods retained therein after the blind body along with the horizontal rods thereof are properly trimmed in width according the telescopic upper beam adjusted to fit to the size of a window frame so that the pull cord can be properly held in place according to the adjustment of the retaining pieces to maintain the overall beauty of the blind body in display, increasing the variable changes in decoration and assembly of the present invention to achieve widespread use and boost the competitive power thereof.

2. The operation mechanism for Romanian blind as claimed in claim 1 wherein the cord-passage holes of the retaining pieces are better located in vertical position relative to that of the clamping parts thereof.

3. The operation mechanism for Romanian blind as claimed in claim 1 wherein each retaining piece can also be made up of a pair of symmetric retaining plates mutually bound together via a torsional spring with an upper and a lower clamping parts extending at one side thereof to precisely clamp tight the elongated through holes and the horizontal rods of the blind body thereby and a pair of upper/lower cord-passage holes correspondingly protruding at the other side thereof for the pull cord to be led downwards there-through respectively.
